(19) United States
(12) Patent Application Publication
(10) Pub. No.: US 2022/0270161 A1
(43) Pub. Date: Aug. 25, 2022

(54) SYSTEM AND METHOD FOR AN ELECTRONIC MENU

(71) Applicant: Toshiba TEC Kabushiki Kaisha, Shinagawa-ku (JP)

(72) Inventors: Jia ZHANG, Irvine, CA (US); Adrian NEILSON, Irvine, CA (US)

(21) Appl. No.: 17/184,318

(22) Filed: Feb. 24, 2021

(51) Int. Cl. G06Q 30/06; G06F 16/9535; G06Q 10/02; G06Q 50/12; G06F 21/32; G06K 9/00

(52) U.S. Cl. CPC G06Q 30/0641; G06F 16/9535; G06Q 10/02; G06Q 50/12; G06F 21/32; G06K 9/00288

(57) ABSTRACT

An electronic menu system. The system includes a reservation server comprising memory storing customer information, a network interface, and a processor configured to communicate with a handheld data device via the network interface. The handheld data device includes an imaging engine comprising a digital camera being in data communication with facial recognition software. A search engine is in data communication with the memory of the reservation server. A query engine retrieves a plurality of questions from the memory of the reservation server and displays a plurality of questions on a touch screen display. A display engine displays a custom menu, the custom menu being compiled in part based on an answer from a customer to one or more of the plurality of questions and in part from the customer information.

### TECHNICAL FIELD

This application relates generally menus, including menus typically used in restaurants.

### BACKGROUND

Menus in restaurant are generally in hard copy form, with menu items being in a fixed order. Even with an electronic menus, items are listed in a fixed arrangement. Menus are not suited for dynamically compiling information for specific users or groups of users.

### BRIEF DESCRIPTION OF THE DRAWINGS

Various embodiments will become better understood with regard to the following description, appended claims and accompanying drawings wherein:

FIG. 1 is an example embodiment of a system for an electronic menu;

FIG. 2 is an example embodiment of a networked digital device comprising an electronic menu system;

FIG. 3 is an example embodiment of a digital device system such as a smartphone or tablet computer; and

FIG. 4 is a flowchart of an example embodiment for a method of use of a system for an electronic menu.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

An electronic menu system is connected in data communication with a reservation system. The reservation system can include a reservation server and can receive and store information including the number of people in a party at a restaurant, the number of children, if any, and identifying information such as a customer's name. In an embodiment, the information stored in the reservation system can be input by a system administrator, such as a restaurant's host, hostess, or wait staff. The reservation system, or components thereof, can store user identifying information for future use. As used herein, unless otherwise noted, “user” and “customer” are used interchangeably, with both terms referring to the person(s) using the electronic menu system according to the description herein.

The electronic menu system can facilitate a better user experience by providing a dynamically changeable menu depending on the associated information stored in the reservation system, or on a connected electronic device linked to the reservation system. For example, the electronic menu system can display a custom menu based on the customer name, and other identifying data including the customer's age, gender, previous orders at the restaurant, and the like. In an embodiment, a digital camera can be associated with the electronic menu system, including being installed on, or integrated with, a device displaying the electronic menu. The digital camera can utilize tools such as facial recognition software to determine information related to the user, such as the user's age and gender. The electronic menu can also query a user to determine the user's taste preferences, tolerance to wait times, calorie preferences, and the like. The menu queries can be varied depending on the restaurant's or system administrator's preferences. The system administrator can be, for example, the owner or manager of the restaurant.

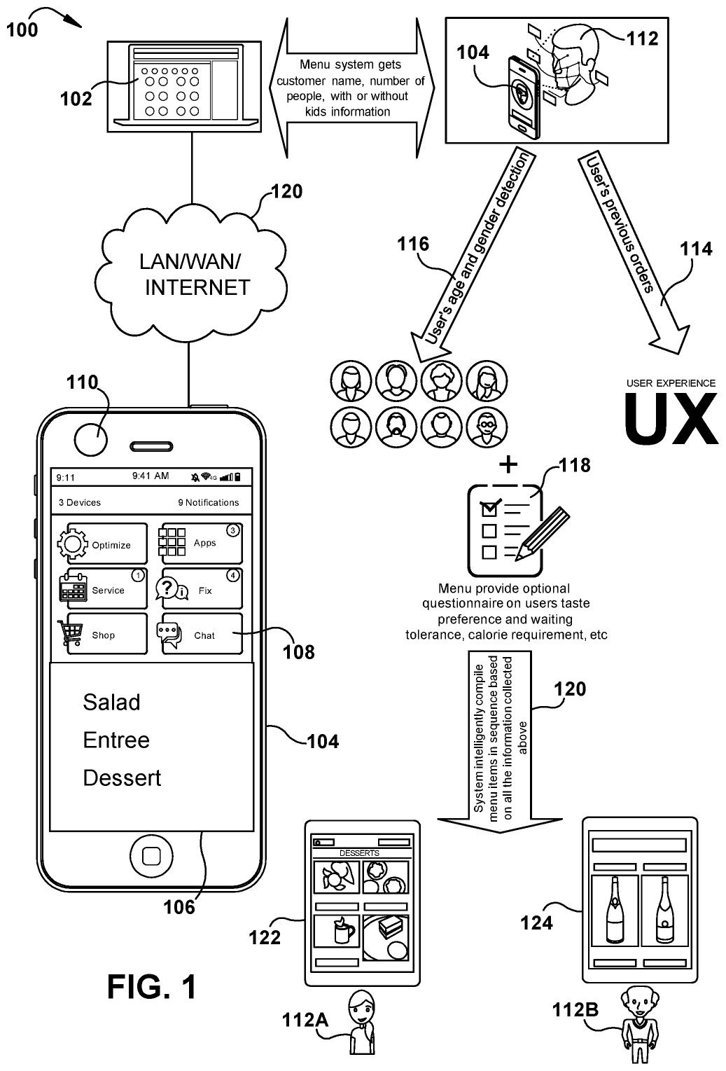

FIG. 1 illustrates an example embodiment of an electronic menu system 100. A reservation system 102 and handheld data device 104 capable of displaying an electronic menu 106 can be in mutual data communication by network cloud 120, suitably comprised of a local area network (LAN), wide area network (WAN) which may comprise the Internet, or any combination thereof. Network connectivity is provided by any suitable wireless or wired technology. Operation of example embodiments disclosed herein are operable solely within a LAN or subnet. WAN or Internet connectivity is not required.

In the example embodiment of FIG. 1, the reservation system 102 is operable as a server. As illustrated in FIG. 1 the handheld data device 104 is shown as a smartphone, but it can be any suitable data device, such as a notebook computer, tablet computer, and the like. When menu recommendations are issued from the reservation system 102, they can be routed to the handheld data device 104 associated with a user, such as a restaurant customer. The electronic menu system 100 can implement menu recommendations that can be displayed on the handheld data device 104. The electronic menu system 100 can use machine learning suitably implemented on commercially available software, such as TensorFlow, Amazon Machine Learning, Accord.NET or Apache Mahout.

Handheld data device 104 includes a touchscreen user interface 108 to display received menu recommendations and provide user feedback. When a received menu recommendation is displayed, the user may place menu orders manually or elect to have associated orders placed automatically with one or more preselected menu choices, or both.

Handheld data device 104 includes a digital camera 110 that can be used to detect a user, including using facial recognition software, to gather identifying information including the user's age, approximate age, gender, and the like The camera can also be utilized to gather identifying information of others associated with the user, including the approximate ages and genders of other persons in the user's party, as well as the number of persons in the party, the number of children, the relative placement of all members of the party at a table, and the like.

In an example method of the electronic menu system 100, a user 112 can use the handheld data device 104, including positioning for facial recognition to provide inputs to the electronic menu system 100. For example, at a remote location (relative to the restaurant), or in the restaurant, user information can be gathered passively, e.g., from the digital camera 110, or actively, e.g., from user input using the touchscreen user interface 108. Information gathered from the user 112 interacting with the handheld data device 104 can be used to populate data in the electronic menu system 100, including in the reservation system 102, for the particular user 112, as well as to check the data in the electronic menu system 100 for stored information related to the user 112. Stored information related to the user 112 can be retrieved to provide the user with menu selections 114 that reflect previous interaction with the electronic menu system 100. In addition, or alternatively, the information related to other party information 116, including the user, or user's party's age(s), gender(s), and the like can be gathered, and used stored in memory as customer information, and further utilized for presenting to the customer a custom menu.

Continuing to refer to FIG. 1, at 118, the electronic menu system 100 can optionally display to the user a request 118 for additional information related to the user or the user's party, including taste preferences, wait time preferences, calorie preferences, and the like.

At 120, the electronic menu system 100 displays a selection of menu items that can be customized based on user information gathered and analyzed by the electronic menu system 100. The menu items can be compiled by the electronic menu system 100 from system-generated and stored information. By way of example, a first customized menu 122 displaying dessert choices, can be presented for a first user 112A based on data, including first user information, in the electronic menu system 100 relating to the first user 112A. Likewise, a second customized menu 124 displaying wine choices, can be presented for a second user 112B based on data, including second user information, in the electronic menu system 100 relating to the second user 112B.

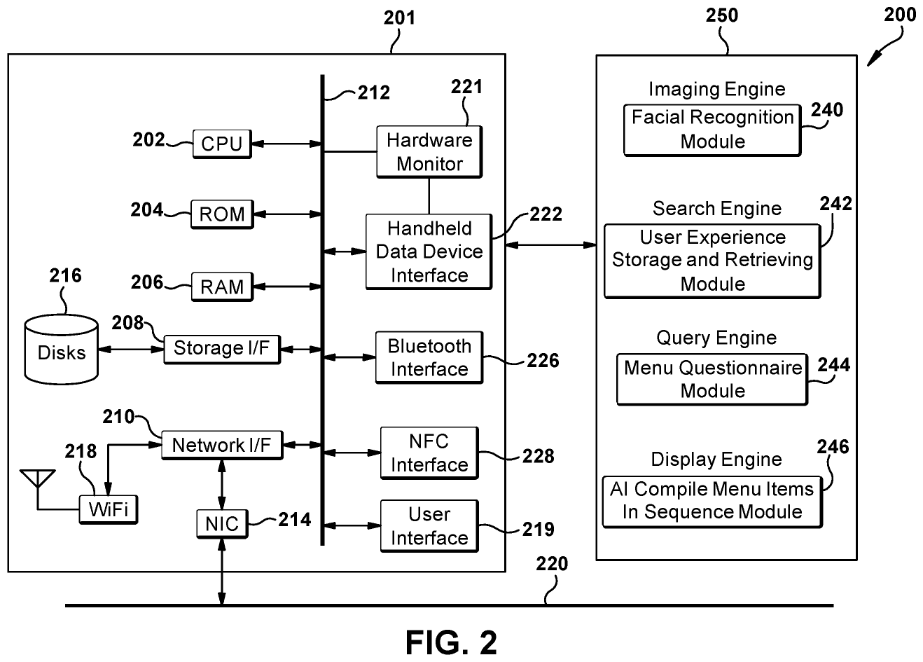

Turning now to FIG. 2 illustrated is an example portion of the electronic menu system 100, including the portion comprising the components 200 suitably comprised within a handheld data device 104 of FIG. 1. It will be appreciated that the electronic menu system 100 includes a controller 201 which is itself a computer system, and can be suitably comprised within the reservation system 102. Included in controller 201 are one or more processors, such as that illustrated by processor 202. Each processor is suitably associated with non-volatile memory, such as read only memory (ROM) 204, and random access memory (RAM) 206, via a data bus 212.

Processor 202 can also be in data communication with a storage interface 208 for reading or writing data with storage 216, suitably comprised of a hard disk, optical disk, solid-state disk, cloud-based storage, or any other suitable data storage as will be appreciated by one of ordinary skill in the art.

Processor 202 can also be in data communication with a network interface 210 which provides an interface to a network interface controller (NIC) 214, which in turn provides a data path to any suitable wired or physical network connection 220, or to a wireless data connection via a wireless network interface, such as Wi-Fi 218. Example wireless connections include cellular, Wi-Fi, wireless universal serial bus (wireless USB), satellite, and the like. Example wired interfaces include Ethernet, USB, IEEE 1394 (FireWire), Lightning, telephone line, or the like. Processor 202 is also in data communication with a hardware monitor 221, suitably amassing state data from subassemblies, sensors, digital thermometers, or the like, and suitably including digital state date including device codes, such as device error codes. Processor 202 can also be in data communication with a handheld data device interface 222, with Bluetooth interface 226 and NFC interface 228 via data bus 212.

Processor 202 can also be in data communication with any suitable user input/output (I/O) interface (not shown) which provides data communication with user peripherals, such as displays, keyboards, mice, track balls, touch screens, or the like.

Handheld data device interface 222 is suitable for data communication with components of the handheld data device 104. In the illustrated example, these components include an imaging engine, suitably comprised of digital camera hardware including a facial recognition module 240, a search engine, suitably comprised of search and retrieval hardware including a user experience storage and retrieving module 242, a query engine, suitably comprised of a user-interactive hardware for a menu questionnaire module 244, and a display engine, suitably comprised of customizable, including artificial intelligence produced, menu items in sequence module 246. These subsystems together with others, such as user experience storage and retrieving module, a menu user experience module, and an interface module permitting a user to communicate with the components 200 module, comprise handheld data device functional units 250. It will be understood that functional units are suitably comprised of intelligent units, including any suitable hardware or software platform.

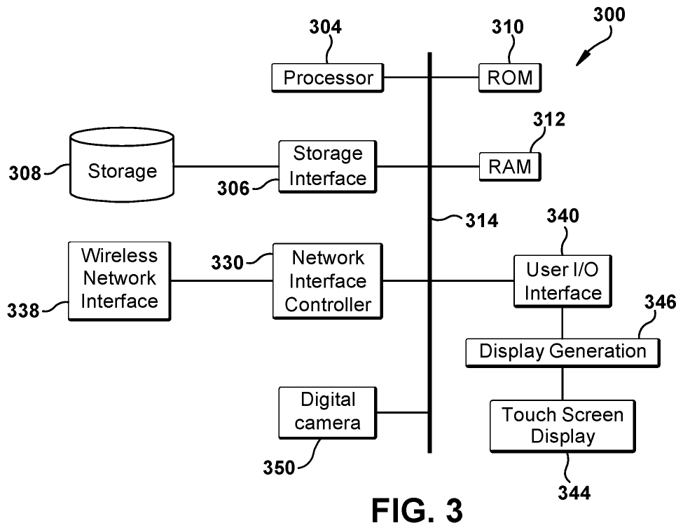

Turning now to FIG. 3, illustrated is an example of a digital device system 300 suitably comprising handheld data device 104 of FIG. 1. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable network or device connection, such as a suitable wireless data connection via wireless network interface 338. A suitable data connection to an MFP or server is via a data network, such as a local area network (LAN), a wide area network (WAN), which may comprise the Internet, or any suitable combination thereof. A digital data connection is also suitably made with the reservation system 102, such as via Bluetooth, optical data transfer, Wi-Fi direct, or the like.

Processor 304 is also in data communication with a user input/output (I/O) interface 340 which provides data communication with user peripherals, such as touch screen display 344 via display generator 346, as well as keyboards, mice, track balls, touch screens, or the like. It will be understood that functional units are suitably comprised of intelligent units, including any suitable hardware or software platform.

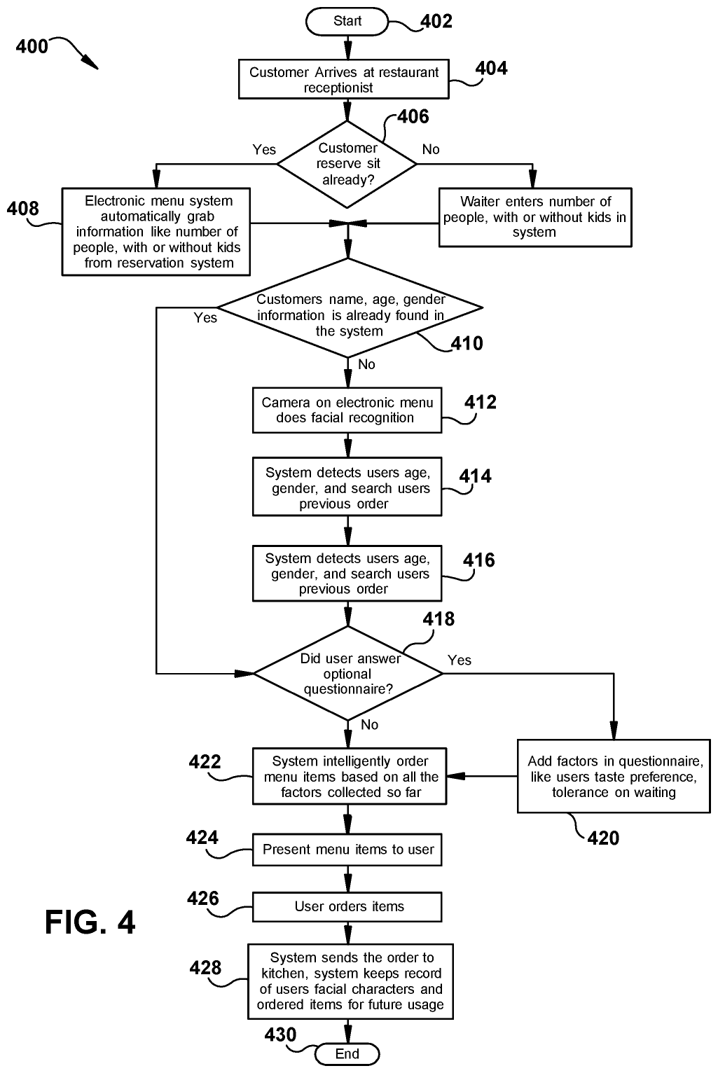

FIG. 4 illustrates a flowchart of an example embodiment of a method of use 400 for the electronic menu system 100. The process commences at block 402 and proceeds to block 404 where a customer arrives at a restaurant. In an embodiment, the customer interacts with a host or hostess at a restaurant. In an embodiment, the customer is near the restaurant and using a smartphone app to interact with the restaurant. At decision point 406, if the customer does not have reserved seating, or is not seated, the host, hostess, or waiter enters customer information into the reservation system, including by way of example, the number of persons in the party, including the number of children. Likewise, customer information is retrieved from the reservation system, if available. If, at 406, the customer is a walk-in customer, the host, hostess, or wait staff can inter data into the reservation system relating to the customer, including the number of people, including children, and can lead the customer to a table for seating. The customer can use a handheld data device 104 to access and interact with the electronic menu system 100. The handheld data device 104 can gather customer information, including facial characteristics of the user, the number of persons in the party, including the number of children. At 410 the electronic menu system 100 queries system memory to determine if the customer information is stored for retrieval. If yes at 410 the customer can be prompted to answer optional questions from a questionnaire of preferences at 418. If no at 410, a camera integrated with the handheld data device 104 can gather customer information, including by facial recognition, at 412. The electronic menu system 100 can detect the customer's age, or approximate age, gender, and can retrieve information from previous orders. At 418, the user is prompted to answer optional questions from a questionnaire of preferences at 418. If the optional questions from the questionnaire are answered, the information is added to the information already compiled for the user at 420. At 422 all the information known by the electronic menu system 100 can be analyzed to formulate a menu customized to the user. The menu is presented to the user at 424, and the user can order items at 426. The electronic menu system 100 sends the order to the restaurant kitchen, and records the gathered user information, including, for example, the user's facial characteristics, storing it in system memory for future use. The method ends at 430.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. An electronic menu system comprising:
a reservation server comprising,
memory storing customer information,
a network interface, and
a processor configured to communicate with a handheld data device via the network interface; and
wherein the handheld data device includes,
an imaging engine comprising a digital camera being in data communication with facial recognition software;
a search engine; the search engine being in data communication with the memory of the reservation server;
a query engine, the query engine retrieving a plurality of questions from the memory of the reservation server and displaying the plurality of questions on a touch screen display; and
a display engine, the display engine displaying on the touch screen display a custom menu, the custom menu being compiled in part based on an answer from a customer to one or more of the plurality of questions and in part from the customer information.

2. The electronic menu system of claim 1, wherein the handheld data device is a wireless device comprising data communication via a wide area network.

3. The electronic menu system of claim 1 wherein the custom menu is produced by artificial intelligence.

4. The electronic menu system of claim 1 wherein the imaging engine recognizes the customer and the custom menu is displayed based on the customer information retrieved from the memory of the reservation server.

5. The electronic menu system of claim 1 wherein the imaging engine recognizes the customer via facial recognition and the custom menu is displayed based on the customer information retrieved from the memory of the reservation server and the custom menu displays in a sequence of customer preferences stored in the memory of the reservation server.

6. The electronic menu system of claim 1 wherein the query engine receives customer preferences from the plurality of questions and the custom menu displays in a sequence of menu items according to the customer preferences.

7. The electronic menu system of claim 6, wherein the plurality of questions relates to one of the customer's taste, the customer's time constraints, and the customer's calorie preferences.

8. The electronic menu system of claim 1 wherein the handheld data device further includes a user interface module for allowing the customer to interact with the reservation server.

9. A method comprising:
in an electronic menu system for producing and displaying a custom menu to a customer of a restaurant, the electronic menu system including a reservation system, the reservation system including a processor and memory and being in data communication with a handheld data device, the handheld data device including,
an imaging engine comprising a digital camera being in data communication with facial recognition software;
a search engine; the search engine being in data communication with the memory of the reservation system server;
a query engine, the query engine retrieving a plurality of questions from the memory of the reservation system server and displaying the plurality of questions on a touch screen display; and
a display engine, the display engine displaying on the touch screen display the custom menu;
receiving, by the reservation system, one of a name of the customer, a number of people in the customer's party, and a number of children in the customer's party;
receiving, from the handheld data device, via the imaging engine one of an identity of the customer, an approximate age of the customer, and a gender of the customer;
receiving, by the handheld data device from the reservation system, via the search engine, information relating to the customer;
receiving, from the handheld data device, via the query engine one or more answers to the plurality of questions from the customer, the plurality of questions relating to menu preferences;
presenting on the handheld data device, via the display engine, the custom menu.

10. The method of claim 9 wherein the handheld data device further is a wireless device comprising data communication via a wide area network.

11. The method of claim 9, wherein the handheld data device comprises a touch screen display.

12. The method of claim 9, wherein the custom menu is produced by artificial intelligence.

13. The method of claim 9, wherein the imaging engine recognizes the customer and the custom menu is displayed based on customer information retrieved from the memory of the reservation system server and the custom menu displays in a sequence of customer preferences stored in the memory of the reservation system server.

14. The method of claim 9, wherein the plurality of questions relates to one of the customer's taste, the customer's time constraints, and the customer's calorie preferences.

15. An electronic menu system comprising:
a reservation server comprising,
memory storing first customer information and second customer information, the first customer information relating to a first customer and including the first customer's facial image and the first customer's food preferences,
a network interface, and
a processor configured to communicate with the first customer via a first handheld data device via the network interface and configured to communicate with a second customer via a second handheld data device via the network interface; and
wherein each of the first handheld data device and the second handheld data device includes,
an imaging engine comprising a digital camera being in data communication with facial recognition software, and imaging the first customer's facial image and the second customer's facial image;
a search engine; the search engine being in data communication with the memory of the reservation server, the search engine of the first handheld data device retrieving first customer's food preferences based on a match of the first customer's facial image;
a query engine, the query engine retrieving a plurality of questions from the memory of the reservation server and displaying the plurality of questions on a touch screen display of each of the first and second handheld data devices to the first customer and the second customer, respectively, and sending to the memory one or more answers from the first and second customers, respectively; and
a display engine, the display engine displaying on the touch screen display of the first data device a first custom menu to the first customer, the first custom menu being compiled from the first customer information retrieved from the reservation server, and displaying on the touch screen display of the second handheld data device a second custom menu to the second customer, the second custom menu being compiled from an answer to one or more of the plurality of questions from the second customer.

16. The electronic menu system of claim 15, wherein the first handheld data device is a wireless device comprising data communication via a wide area network.

17. The electronic menu system of claim 15, wherein the second custom menu is produced by artificial intelligence.

18. The electronic menu system of claim 15, wherein the imaging engine is configured to store an image of the second customer in the memory of the reservation server.

19. The electronic menu system of claim 15, wherein the first customer information is augmented by the answer from the first customer stored in the memory of the reservation server.

20. The electronic menu system of claim 15, wherein the query engine receives the answers from the second customer and stores the answers of the second customer in the memory of the reservation server.
